(19) United States
(12) Patent Application Publication
(10) Pub. No.: US 2024/0005040 A1
(43) Pub. Date: Jan. 4, 2024

(54) CARDINALITY MODELS FOR PRIVACY-SENSITIVE ASSESSMENT OF DIGITAL COMPONENT TRANSMISSION REACH

(71) Applicant: Google LLC, Mountain View, CA (US)

(72) Inventors: Jiayu Peng, Sunnyvale, CA (US); Meng-Hao Li, Los Angeles, CA (US); Chenwei Wang, Mountain View, CA (US); Sanjay Lal Vasandani, Los Angeles, CA (US); Raimundo Mirisola, Los Angeles, CA (US)

(21) Appl. No.: 17/856,084

(22) Filed: Jul. 1, 2022

(51) Int. Cl. G06F 21/62; G06F 16/2455

(52) U.S. Cl. CPC G06F 21/6263; G06F 16/24558; G06F 21/6227

(57) ABSTRACT

In one aspect, there is provided a method performed by one or more computers for privacy-sensitive assessment of digital component transmission reach based on cardinalities of subset unions of a collection of user sets, the method including: receiving a request to determine a number of users that are included in a target group of users that received at least one transmission of a digital component, where the request includes a set expression defined in terms of the collection of user sets, generating an alternative representation of the set expression in terms of primitive sets, applying a cardinality model to each primitive to generate a cardinality of each primitive set as a linear combination of cardinalities of subset unions of the collection of user sets, and determining the number of users included in the target group of users based on the cardinalities of the primitive sets.

### BACKGROUND

This specification relates to privacy-sensitive assessment of digital component transmission reach.

Digital components are discrete units of digital content or digital information, which can be incorporated into various electronic documents or applications. Digital components can be provided by a publisher and transmitted for presentation with various electronic documents or applications at user devices. Digital component transmission reach refers to a number of distinct users who received at least one transmission of the digital component when the digital component is transmitted to user devices.

### SUMMARY

This specification describes a system implemented as computer programs on one or more computers in one or more locations for privacy-sensitive assessment of digital component transmission reach. The system can determine a number of users who are included in a target group of users, e.g., who received at least one transmission of the digital component. The target group of users can be defined in terms of one or more user sets that can be specified in any appropriate manner. In one example, one or more user sets can include users who received at least one transmission of the digital component by way of a respective publisher. In another example, one or more user sets can include users who received at least one transmission of the digital component in a respective window of time. Based on the number of users included in the target group, the system can determine, for example, how different user sets are correlated and/or how different user sets contribute incremental reach to each other in a manner that respects privacy of individual users.

According to a first aspect there is provided a method performed by one or more computers for privacy-sensitive assessment of digital component transmission reach based on cardinalities of subset unions of a collection of user sets, the method including: receiving a request to determine a number of users that are included in a target group of users that received at least one transmission of a digital component. The request includes a set expression specifying the target group of users. The set expression is defined in terms of the collection of user sets. Each user set includes one or more users satisfying a set-specific inclusion criterion.

The method further includes, in response to receiving the request: generating an alternative representation of the set expression in terms of primitive sets of the collection of user sets, applying a cardinality model having a set of cardinality model parameters to each primitive set included in the alternative representation of the set expression to generate a cardinality of each primitive set as a linear combination of cardinalities of subset unions of the collection of user sets, determining the number of users included in the target group of users based on the cardinalities of the primitive sets included in the alternative representation of the set expression, and automatically providing a notification identifying the number of users included in the target group of users in response to the request.

In some implementations, the cardinality model is defined by a matrix, where the cardinality model parameters define entries of the matrix, and the entries of the matrix define weights of linear combinations used to generate cardinalities of primitive sets in terms of cardinalities of subset unions.

In some implementations, for each primitive set included in the alternative representation of the set expression, applying the cardinality model to the primitive set includes: mapping the primitive set to: (i) a collection of subset unions, and (ii) for each subset union, a respective weight of the subset union in the linear combination, and generating the cardinality of the primitive set as a linear combination of the cardinalities of the subset unions weighted by the weights of the subset unions.

In some implementations, the entries of the matrix comprise −1, 0, and +1.

In some implementations, the matrix defining the cardinality model is a sparse matrix.

In some implementations, the set of cardinality model parameters are precomputed.

In some implementations, the set of cardinality mode parameters are dynamically generated in response to receiving the request.

In some implementations, a primitive set of the collection of user sets is defined by a set intersection that intersects, for each user set in the collection of user sets, either the user set or a complement of the user set.

In some implementations, a subset union of the collection of user sets is defined by a set union of one or more user sets in the collection of user sets.

In some implementations, generating the alternative representation of the set expression in terms of primitive sets of the collection of user sets includes: replacing each user set in the set expression by a union of corresponding primitive sets.

In some implementations, for each user set in the collection of user sets, the set-specific inclusion criterion specifies that users included in the user set received at least one transmission of the digital component by way of a respective publisher.

In some implementations, for each user set in the collection of user sets, the set-specific inclusion criterion specifies that users included in the user set received at least one transmission of the digital component in a respective window of time.

In some implementations, the set expression is defined as a string including set identifiers and set operations.

In some implementations, the set operations include one or more of: set union operations, set intersection operations, and set difference operations.

According to a second aspect, there is provided a system including: one or more computers, and one or more storage devices communicatively coupled to the one or more computers, where the one or more storage devices store instructions that, when executed by the one or more computers, cause the one or more computers to perform the operations of the method of any preceding aspect.

According to a third aspect, there are provided one or more non-transitory computer storage media storing instructions that when executed by one or more computers cause the one or more computers to perform the operations of the method of any preceding aspect.

Particular embodiments of the subject matter described in this specification can be implemented so as to realize one or more of the following advantages.

The systems and methods described in this specification can determine the number of users included in a target group of users, e.g., who received at least one transmission of a digital component (e.g., digital component transmission reach) in a privacy-sensitive manner. In particular, the systems and methods described in this specification can determine digital component transmission reach based on cardinalities of subset unions of a collection of user sets. Because the subset unions of the collection of user sets can generally include a larger number of users than, e.g., primitive sets, the privacy of individual users can be effectively preserved.

Moreover, the systems and methods described in this specification can perform privacy-sensitive assessment of digital component transmission reach for a target group of users specified by user sets defined according to any appropriate set-specific criterion. For example, the target group of users can be defined based on ten user sets, where each user set includes users who received at least one transmission of a digital component by means of a respective publisher. Accordingly, the systems and methods described in this specification can assess digital component transmission reach for a target group of users that may otherwise be difficult to assess using other available systems.

Moreover, the systems and methods described in this specification can perform any appropriate type of assessment of digital component transmission reach in a privacy-sensitive manner. For example, the systems and methods described in this specification can determine how a first set of users in the target group correlates with a second set of users in the target group. In some cases, where user sets include users who received at least one transmission of the digital component by means of a respective publisher, the system can determine how different publishers contribute incremental reach to each other. Accordingly, based on this assessment, the systems and methods described in this specification can enable effective planning and allocation of resources, thereby reducing the overall use of processing resources and maximizing the efficiency of transmission of the digital component.

Furthermore, the systems and methods described in this specification apply a cardinality model that can include a set of cardinality model parameters that are defined by a matrix. In some cases, the matrix can be a sparse matrix, e.g., it can include more than a threshold number or proportion of zero-value cardinality model parameters. Applying the cardinality model that is defined by a sparse matrix can significantly reduce the amount of resources (e.g., memory and computing power) required to determine the number of users who received at least one transmission of the digital component. Moreover, in some cases, the cardinality model parameters can be determined only once, then stored and reused, thereby reducing the amount of computational resources required even further.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example reach assessment system.

FIG. 2 illustrates example set operations.

FIG. 3 illustrates example primitive sets of a collection of user sets.

FIG. 4 is a flow diagram of an example process for privacy-sensitive assessment of digital component transmission reach.

FIG. 5 is a block diagram of an example environment in which a digital component distribution system transmits digital components from a digital component database for presentation with electronic documents.

FIG. 6 is a block diagram of an example computer system.

Like reference numbers and designations in the various drawings indicate like elements.

### DETAILED DESCRIPTION

This specification describes a system for privacy-sensitive assessment of digital component transmission reach.

As used throughout this document, the phrase “digital components” refers to discrete units of digital content or digital information that can include one or more of, e.g., video clips, audio clips, multimedia clips, images, text segments, or uniform resource locators (URLs). A digital component can be electronically stored in a physical memory device as a single file or in a collection of files, and digital components can take the form of video files, audio files, multimedia files, image files, or text files and include streaming video, streaming audio, social network posts, blog posts, and/or advertising information, such that an advertisement is a type of digital component. Generally, a digital component is defined by (or provided by) a single source (e.g., a digital component provider), but a digital component provided from one source could be enhanced with data from another source (e.g., weather information, real time event information, or other information obtained from another source).

A digital component distribution system (e.g., as described below with reference to FIG. can transmit digital components for presentation with electronic documents to user devices through a publisher (e.g., a website, an application, or any other appropriate type of publisher). For example, if the publisher is a web site, transmitting the digital component can include displaying the digital component on the web site at user devices. As used throughout this document, a “reach” associated with a transmission of a digital component refers to a number of distinct users who received at least one transmission of the digital component.

These features and other features are described in more detail below.

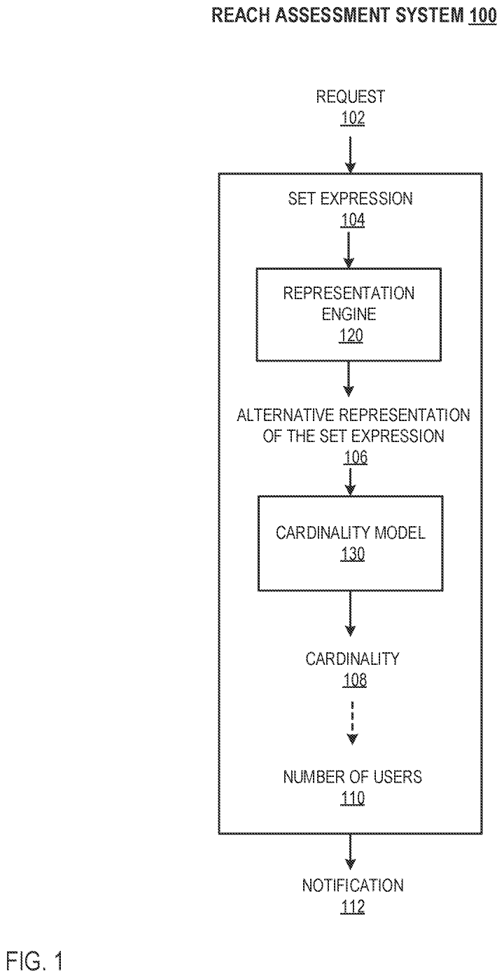

FIG. 1 is a block diagram of an example reach assessment system 100. The reach assessment system 100 is an example of a system implemented as computer programs on one or more computers in one or more locations in which the systems, components, and techniques described below are implemented.

The system 100 can be configured to perform a privacy-sensitive assessment of digital component transmission reach. In other words, the system 100 can determine a number of users 110 that each received at least one transmission of the digital component in a manner that preserves privacy of individual users. Throughout this specification, a group of users that each received at least one transmission of the digital component can be referred to, e.g., as a “target group” of users.

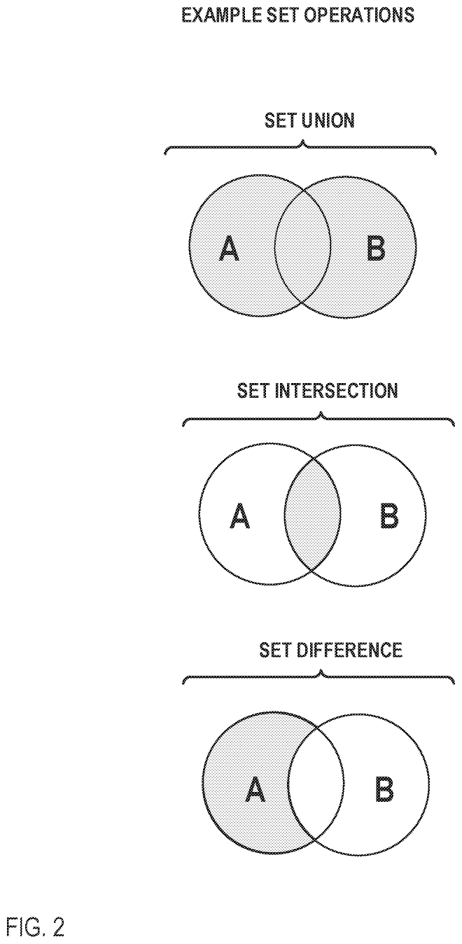

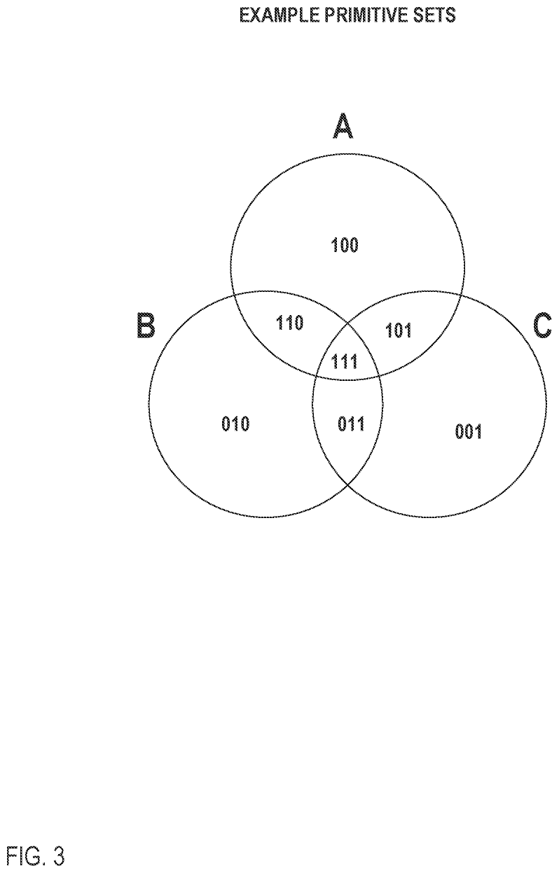

The system 100 is configured to receive a request 102 to determine the number of users 110 included in the target group of users and, in response to the request, automatically provide a notification 112 identifying the number of users 110 included in the target group. The request 102 can include a set expression 104 specifying the target group of users, where the set expression 104 is defined in terms of a collection of user sets. Each user set can include one or more users who received at least one transmission of the digital component. Generally, each user set can include any appropriate number of users, e.g., 1 user, 10 users, 1 thousand users, 1 million users, or any other appropriate number of users. As a particular (simplified) example, as illustrated in FIG. 2, the collection of user sets can include two user sets: user set A and user set B. As another particular (simplified) example, as illustrated in FIG. 3, the collection of user sets can include three user sets: user set A, user set B, and user set C. Each of “A,” “B,” and “C” is a set identifier. The collection of user sets can include any appropriate number of user sets, e.g., 2 user sets, 3 user sets, 5 user sets, 10 user sets, or any other appropriate number of user sets.

Each user set can include one or more users satisfying a set-specific inclusion criterion. Generally, the set-specific inclusion criterion can define any appropriate inclusion criterion. In one example, the set-specific inclusion criterion can specify that users included in the user set received at least one transmission of the digital component by way of a respective publisher. In such cases, each of A, B, and C illustrated in FIG. 3 can correspond to, e.g., a user set that includes users who received at least one transmission of the digital component by way of a website, a social media platform, and a mobile application, respectively. In another example, the set-specific inclusion criterion can specify that users included in the user set received at least one transmission of the digital component in a respective window of time. In such cases, each of A, B, and C illustrated in FIG. 3 can correspond to, e.g., a user set that includes users who received at least one transmission of the digital component over a first day, a second day, and a third day, respectively.

As described above, the target group of users can be specified through the set expression 104 that can be defined in terms of the collection of user sets. The set expression 104 can be defined as a string that includes set identifiers (e.g., A, B, and C) and set operations. The set operations can include one or more of: set union operations, set intersection operations, and set difference operations. Example set operations are illustrated in FIG. 2.

A “set union” of a collection of sets, where each set in the collection of sets includes one or more elements, refers to a set of all elements in the collection of sets. The set union operation of set A and set B results in a set that is a combination of all elements included in both set A and set B. As illustrated in FIG. 2, the set union is represented by the shading of the whole area of the Venn diagram. A “set intersection” of a first set and a second set refers to a set that includes only those elements that are included in both the first set and the second set. As illustrated in FIG. 2, the set intersection operation of set A and set B is represented by the shaded area of the Venn diagram that overlaps both set A and set B. A “set difference” of a first set and a second set refers to a set that includes all elements that are included in the first set, but not included in the second set. As illustrated in FIG. 2, the set difference operation of set A and set B is represented by the shaded area of the Venn diagram that covers set A, but does not cover set B.

As a particular example, the set expression 104 that specifies the target group of users who received at least one transmission of the digital component can take the following form:

(A∪B−A)∪C (1)

where ∪ represents the set union operation, and − represents the set difference operation. Although equation (1) includes only three user sets A, B, and C, in general, the set expression 104 can include any appropriate number of user sets, e.g., 10 user sets, or 20 user sets.

The reach assessment system 100 can determine the number of users 110 included in the target group, which is specified by the set expression 104, using: (i) a representation engine 120 and (ii) a cardinality model 130, each of which is described in more detail next.

The representation engine 120 can be configured to process the set expression 104 to generate an alternative representation 106 of the set expression 104 in terms of primitive sets of the collection of user sets. A “primitive set” of the collection of user sets refers to a set intersection that intersects, for each user set in the collection of user sets, either the user set or a complement of the user set. A “complement” of a given set refers to a set that includes all elements that are not included in the given set. Example primitive sets are illustrated in FIG. 3. Each primitive set can be represented by a combination of digits that include, e.g., 0 and 1. For example, as illustrated in FIG. 3, in the case where the collection of sets includes three user sets A, B, and C, each primitive set can be represented by a combination of three digits, e.g., (100), and there can be a total of seven primitive sets. As another example, if the collection of user sets includes four user sets, then each primitive set can be represented by a combination of four digits, e.g., (1000), and there can be a total of fifteen primitive sets.

As illustrated in FIG. 3, the user set A can be represented in terms of the following primitive sets: (100), (110), (101), and (111). The user set B can be represented in terms of the following primitive sets: (010), (110), (011), and (111). Lastly, user set C can be represented in terms of the following primitive sets: (001), (011), (101), and (111). Specifically, each user set can be represented as a union of corresponding primitive sets. For example, the user sets A, B, and C illustrated in FIG. 3 can each be represented as follows:

A=R(100)∪R(110)∪R(101)∪R(111)

B=R(010)∪R(110)∪R(011)∪R(111)

C=R(001)∪R(011)∪R(101)∪R(111) (2)

where R(⋅) indicates the primitive sets that are mutually exclusive.

The representation engine 120 can process the set expression 104 to generate the alternative representation 106 of the set expression 104 in terms of primitive sets of the collection of user sets. The representation engine 120 can replace each user set in the set expression 104 by the union of corresponding primitive sets. For example, the representation engine 120 can replace each of A, B, and C in equation (1) with the union of corresponding primitive sets in equation (2). As a particular example, the alternative representation 106 of the set expression 104 in terms of primitive sets can take the following form:

(A∪B−A)∪C=R(010)∪R(011)∪R(101)∪R(101)∪R(111) (3)

After generating the alternative representation 106 of the set expression 104 in terms of primitive sets, the system 100 can apply the cardinality model 130 to each primitive set included in the alternative representation 106 of the set expression 104 to determine a cardinality 108 of each primitive set. A “cardinality” of a set, where the set includes one or more elements, refers to the number of elements in the set. As a particular example, if a primitive set (e.g., R(010)) includes 5 users, then the cardinality of the primitive set (e.g., |R(010)|) is 5. By applying the cardinality model 130 to each primitive set, the system 100 can determine the number of users included in each primitive set.

The system 100 can determine the number of users 110 included in the target group of users as a linear combination of cardinalities 108 of primitive sets. In other words, the system 100 can determine the number of users 110 included in the target group as a linear combination of the number of users included in each primitive set. As a particular example, if the set expression 104 that specifies the target group of users is defined by equation (1) above, then the system 100 can determine the number of users 110 included in the target group as follows:

|(A∪B−A)∪C|=|R(010)|+|R(011)|+|R(101)|+|R(101)|+|R(111)| (4)

where |(A∪B−A)∪C| is the cardinality of the set expression 104 (e.g., the number of users 110 included in the target group), and |R(⋅)| is the cardinality 108 of a primitive set (e.g., the number of users included in the primitive set). In this manner, the system 100 can determine the number of users 110 included in the target group based on cardinalities 108 of primitive sets.

As described above, the system 100 can apply the cardinality model 130 to each primitive set included in the alternative representation 106 of the set expression 104 to generate the cardinality 108 of each primitive set (e.g., |R(⋅)| in equation (4) above). This is described in more detail next.

The cardinality model 130 can generate the cardinality 108 of each primitive set (e.g., |R(⋅)| in equation (4) above) as a linear combination of cardinalities of subset unions of the collection of user sets. A “subset union” of the collection of user sets refers to a set union of one or more user sets in the collection of user sets. For example, if the collection of user sets includes two user sets, e.g., user sets A and B illustrated in FIG. 2, then the subset unions of the collection of user sets can include, e.g., A, B, and A∪B. As another example, if the collection of user sets includes three user sets, e.g., user sets A, B, and C illustrated in FIG. 3, then the subset unions of the collection of user sets can include, e.g., A, B, C, A∪B, B∪C, A∪C, and A∪B∪C.

The cardinality model 130 can be defined by a matrix, where the entries of the matrix define weights of linear combinations used to generate cardinalities 108 of primitive sets in terms of cardinalities of subset unions. In some cases, the matrix can be a “sparse” matrix, e.g., it can include more than a threshold number or proportion of zero-value cardinality model parameters. Moreover, the matrix can include a larger number or proportion of zero-value cardinality model parameters for a larger number of user sets (e.g., 10 user sets), when compared to a smaller number of user sets (e.g., 2 user sets). The columns of the matrix can specify primitive sets (e.g. (101), (110), etc.), while the rows of the matrix can specify subset unions (e.g., A, A∪B, A∪B∪C, etc.). The entries of the matrix can have values −1, 0, and +1.

In some implementations, the set of cardinality model parameters can be precomputed. For example, the system 100 can access a storage medium made available by the system 100 that stores the cardinality model parameters and use the cardinality model parameters when applying the cardinality model 130. In some implementations, the set of cardinality model parameters are dynamically generated in response to receiving the request 102. For example, the system 100 can generate the cardinality model parameters based on the set expression 104 and the alternative representation 106 of the set expression 104 in terms of primitive sets. This is described in more detail below with reference to FIG. 3.

For each primitive set, the system 100 can apply the cardinality model 130 by mapping the primitive set to: (i) a collection of subset unions, and (ii) for each subset union, a respective weight (e.g., defined by the matrix) of the subset union in the linear combination. As a particular example, with reference to FIG. 3, if the collection of user sets includes three user sets A, B, and C, then the cardinality model 130 can generate the cardinality |R(110)| of the primitive set R(110) in terms of the cardinalities of subset unions as follows:

|R(110)|=−|C|+|A∪C|+|B∪C|−|A∪B∪C| (5)

where |C| is the cardinality of subset union C, |A∪C| is the cardinality of subset union A∪C, |B∪C| is the cardinality of subset union B∪C, and |A∪B∪C| is the cardinality of subset union A∪B∪C. The system 100 can perform this process for each of the primitive sets (e.g., |R(⋅)| in equation (4) above) included in the alternative representation 106 of the set expression 104.

After generating the cardinality of each primitive set in this manner, the system 100 can determine the number of users 110 included in the target group. For example, the system 100 can replace the cardinality of each primitive set in equation (4) with the cardinality of each primitive set expressed in terms of subset unions (e.g., defined by equation (5) above). Then, the system 100 can determine the number of users 100 in the target group in any appropriate manner, e.g., using any appropriate set solver.

By determining the number of users 110 included in the target group based on cardinalities of subset unions of a collection of user sets, the system 100 can preserve privacy of individual users when determining the number of users 110 included in the target group. In this manner, the system 100 can perform a privacy-sensitive assessment of digital component transmission reach, e.g., of the number of users who received at least one transmission of the digital component.

After determining the number of users 110 included in the target group of users, the system 100 can automatically provide the notification 112 identifying the number of users 110. For example, the system 100 can provide the notification 112 for output to a user of the system 100 through the API made available by the system 100.

FIG. 2 illustrates example set operations that can be performed by the reach assessment system 100. Generally, the set operations that can be performed by the system can include one or more of: set union operations, set intersection operations, and set difference operations. In the example of FIG. 2, set operations are shown for a collection of user sets that includes two user sets: user set A and user set B.

As described above with reference to FIG. 1, each user set can include one or more users satisfying a set-specific inclusion criterion that can be any appropriate set-specific inclusion criterion. For example, user set A can include users who received at least one transmission of the digital component by way of a particular publisher, e.g., a website, while user set B can include users who received at least one transmission of the digital component and viewed, or accessed, the digital component over a particular duration of time (e.g., 1 minute).

FIG. 3 illustrates example primitive sets of a collection of user sets that the system 100 can use to generate an alternative representation 106 of a set expression 104. As described above with reference to FIG. 1, the set expression 104 can specify a target group of users who received at least one transmission of a digital component. FIG. 3 shows primitive sets for the collection of user sets that includes three user sets: user set A, user set B, and user set C. The subset unions of the collection of user sets illustrated in FIG. 3 can include, e.g., A, B, C, A∪B, B∪C, A∪C, and A∪B∪C.

As described above with reference to FIG. 1, the system 100 can represent each user set in terms of the union of corresponding primitive sets, e.g., as defined above by equation (2). Then, the system 100 can generate the alternative representation 106 of the set expression 104 in terms of primitive sets, e.g., as defined above by equation (3). The system 100 can apply the cardinality model 130 to each primitive set included in the alternative representation 106 of the set expression 104 to generate a cardinality 108 of each primitive set as a linear combination of cardinalities of subset unions of the collection of user sets. Then, the system 100 can determine the number of users 110 included in the target group of users in a privacy-sensitive manner based on cardinalities 108 of subset unions of the collection of user sets.

As described above with reference to FIG. 1, the cardinality model 130 can be defined by a matrix, where the entries of the matrix can define cardinality model parameters. The columns of the matrix can specify primitive sets (e.g. (101), (110), etc.), while the rows of the matrix can specify subset unions (e.g., A, A∪B, A∪B∪C, etc.). The entries of the matrix can have values −1, 0, and +1.

In some implementations, the system 100 can dynamically generate the set of cardinality model parameters. For example, the system 100 can divide the matrix that defines the cardinality model 130 into blocks, and generate the cardinality model parameters for each block of the matrix based on a set of rules.

To define a partition of the matrix into blocks, the system 100 can associate each row and each column of the matrix with a respective score from a set of possible scores given by {1, . . . , P}, where P is the number of user sets in the collection of user sets. In particular, the score for each row of the matrix can be defined as the number of user sets included in the subset union corresponding to the row. The score for each column of the matrix can be defined as the number of “1s” included in a representation of the primitive set corresponding to the column as a string of binary digits (as described above). The system can divide the matrix into P² blocks, where the blocks are indexed by (s₁, s₂), where s₁, s₂∈{1, . . . , P}, and any entry in the matrix included in a row with score s₁ and a column with score s₂ is included in the (s₁, s₂) block.

For each column of the matrix other than the column corresponding to the primitive region represented by a string of “1s”, the system can assign a value of “0” to each entry in the column other than “target” entries included in rows corresponding to subset unions that include each user set associated with value “0” in the binary string representing the primitive region corresponding to the column. Starting from the top of the column, the system can assign value “1” or “4” to each target entry in the column, starting with “4” first and then changing sign for each block.

For the column in the matrix corresponding to the primitive region represented by a string of “1s”, the system can assign value “1” or “4” to each entry in the column, starting with value “1”, and changing sign for each block.

In this manner, the system 100 can dynamically generate the set of cardinality model parameters defined by the entries of the matrix.

The matrix defining the cardinality model is generally a sparse matrix, and the system can efficiently generate and represent the matrix, e.g., by generating and storing data defining only the non-zero parts of the matrix.

In some implementations, rather than directly generating the matrix defining the cardinality model, the system can generate a temporary matrix defining an inverse of the cardinality model, and apply a matrix inversion operation to the temporary matrix to generate the matrix defining the cardinality model. Each row of the temporary matrix can correspond to a respective primitive region, and each column of the temporary matrix can correspond to a respective subset union. For each column of the temporary matrix, the value of an entry in the column is “1” only if the row of the entry corresponds to a primitive region included in the subset union corresponding to the column (each other entry has value “0”).

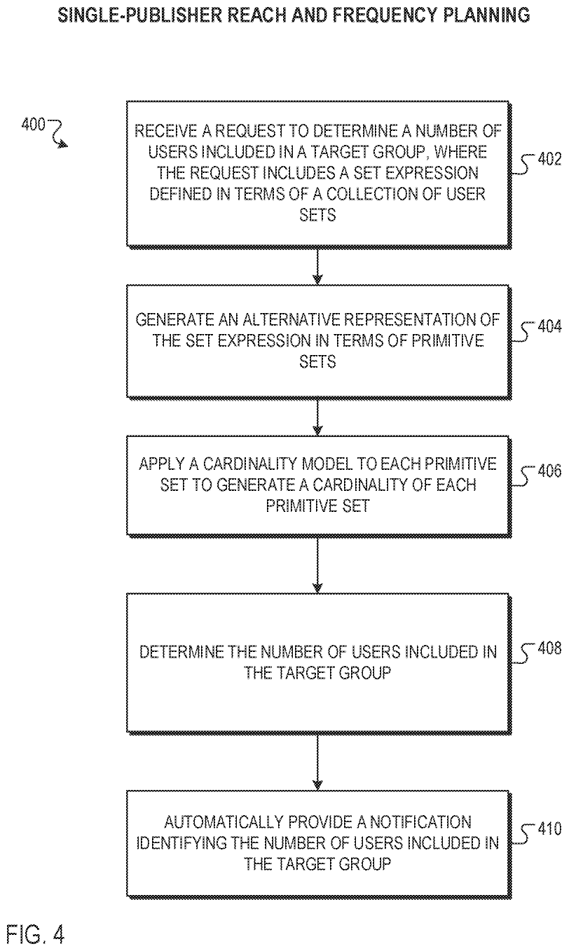

An example process for privacy-sensitive digital component transmission reach that can be performed by the system 100 is described in more detail next with reference to FIG. 4.

FIG. 4 is a flow diagram of an example process for reach assessment. For convenience, the process 400 will be described as being performed by a system of one or more computers located in one or more locations. For example, a reach assessment system, e.g., the reach system 100 of FIG. 1, appropriately programmed in accordance with this specification, can perform the process 400.

The system receives a request to determine a number of users that are included in a target group of users that received at least one transmission of a digital component (402). The request includes a set expression specifying the target group of users. The set expression is defined in terms of the collection of user sets. In some cases, the set expression can be represented as a string that includes set identifiers, and set operations including one or more of: set union operations, set intersection operations, and set difference operations.

Each user set includes one or more users satisfying a set-specific inclusion criterion. The set-specific inclusion criterion can specify, for example, that users included in the user set received at least one transmission of the digital component by way of a respective publisher. In another example, the set-specific inclusion criterion can specify that users included in the user set received at least one transmission of the digital component in a respective window of time.

In response to receiving the request, the system generates an alternative representation of the set expression in terms of primitive sets of the collection of user sets (404). A primitive set of the collection of user sets can be defined by a set intersection that intersects, for each user set in the collection of user sets, either the user set or a complement of the user set. To generate the alternative representation of the set expression, the system can, for example, replace each user set in the set expression by a union of corresponding primitive sets.

The system applies a cardinality model having a set of cardinality model parameters to each primitive set included in the alternative representation of the set expression to generate a cardinality of each primitive set as a linear combination of cardinalities of subset unions of the collection of user sets (406). A subset union of the collection of user sets can be defined by a set union of one or more user sets in the collection of user sets. The cardinality model can be defined by a matrix. The cardinality model parameters can define entries of the matrix, and the entries of the matrix can define weights of linear combinations used to generate cardinalities of primitive sets in terms of cardinalities of subset unions. The entries of the matrix can include, for example, −1, 0, and +1. In some cases, the matrix defining the cardinality model is a sparse matrix. The set of cardinality model parameters can be precomputed, or dynamically generated in response to receiving the request.

For each primitive set included in the alternative representation of the set expression, the system can apply the cardinality model to the primitive set by mapping the primitive set to: (i) a collection of subset unions, and (ii) for each subset union, a respective weight of the subset union in the linear combination. Then, the system can generate the cardinality of the primitive set as a linear combination of the cardinalities of the subset unions weighted by the weights of the subset unions.

The system determines the number of users included in the target group of users based on the cardinalities of the primitive sets included in the alternative representation of the set expression (408).

The system automatically provides a notification identifying the number of users included in the target group of users in response to the request (410).

An example environment in which digital components can be transmitted to user devices is described in more detail next.

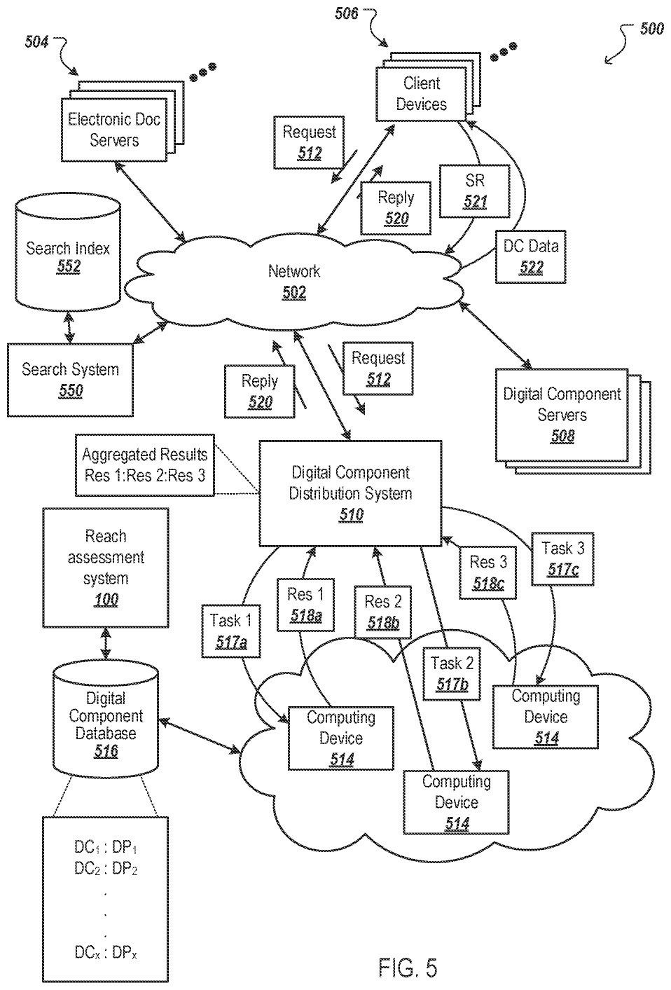

FIG. 5 is a block diagram of an example environment 500 in which a digital component distribution system 510 transmits digital components from a digital component database 516 for presentation with electronic documents.

The reach assessment system 100 can perform a privacy-sensitive assessment of digital component transmission reach after it has been transmitted by the digital component distribution system 510 for presentation with electronic documents to user devices. As described above with reference to FIG. 1, the system 100 can determine a number of users in any target group of users who received at least one transmission of the digital component in a privacy-sensitive manner. For example, the system 100 can determine how a first set of users in the target group correlates with a second set of users in the target group. In some cases, where user sets include users who received at least one transmission of the digital component by means of a respective publisher, the system 100 can determine how different publishers contribute incremental reach to each other. The privacy-sensitive assessment of digital component transmission reach can enable effective planning and allocation of resources, thereby reducing the overall use of processing resources and maximizing the overall efficiency of transmission of the digital component by the digital component distribution system 510.

The example environment 500 includes a network 502, such as a local area network (LAN), a wide area network (WAN), the Internet, or a combination thereof. The network 502 connects electronic document servers 504, client devices 506, digital component servers 508, and a digital component distribution system 510 (also referred to as a “distribution system” 510). The example environment 500 may include many different electronic document servers 504, client devices 506, and digital component servers 508.

A client device 506 is an electronic device that is capable of requesting and receiving resources over the network 502. Example client devices 506 include personal computers, mobile communication devices (e.g., mobile phones), and other devices that can send and receive data over the network 502. A client device 506 typically includes a user application, such as a web browser, to facilitate the sending and receiving of data over the network 502, but native applications executed by the client device 506 can also facilitate the sending and receiving of data over the network 502.

An electronic document is data that presents a set of content at a client device 506. Examples of electronic documents include webpages, word processing documents, portable document format (PDF) documents, images, videos, search results pages, and feed sources. Native applications (e.g., “apps”), such as applications installed on mobile, tablet, or desktop computing devices are also examples of electronic documents. Electronic documents can be provided to client devices 506 by electronic document servers 504 (“Electronic Doc Servers”). For example, the electronic document servers 504 can include servers that host publisher websites. In this example, the client device 506 can initiate a request for a given publisher webpage, and the electronic server 504 that hosts the given publisher webpage can respond to the request by sending machine executable instructions that initiate presentation of the given webpage at the client device 506.

In another example, the electronic document servers 504 can include app servers from which client devices 506 can download apps. In this example, the client device 506 can download files required to install an app at the client device 506, and then execute the downloaded app locally.

Electronic documents can include a variety of content. For example, an electronic document can include static content (e.g., text or other specified content) that is within the electronic document itself and/or does not change over time. Electronic documents can also include dynamic content that may change over time or on a per-request basis. For example, a publisher of a given electronic document can maintain a data source that is used to populate portions of the electronic document. In this example, the given electronic document can include one or more tags or scripts that cause the client device 506 to request content from the data source when the given electronic document is processed (e.g., rendered or executed) by a client device 506. The client device 506 integrates the content obtained from the data source into the given electronic document to create a composite electronic document including the content obtained from the data source.

In some situations, a given electronic document can include one or more digital component tags or digital component scripts that reference the digital component distribution system 510. In these situations, the digital component tags or digital component scripts are executed by the client device 506 when the given electronic document is processed by the client device 506. Execution of the digital component tags or digital component scripts configures the client device 506 to generate a request for one or more digital components 512 (referred to as a “component request”), which is transmitted over the network 502 to the digital component distribution system 510. For example, a digital component tag or digital component script can enable the client device 506 to generate a packetized data request including a header and payload data. The component request 512 can include event data specifying features such as a name (or network location) of a server from which the digital component is being requested, a name (or network location) of the requesting device (e.g., the client device 506), and/or information that the digital component distribution system 510 can use to select one or more digital components provided in response to the request. The component request 512 is transmitted, by the client device 506, over the network 502 (e.g., a telecommunications network) to a server of the digital component distribution system 510.

The component request 512 can include event data specifying other event features, such as the electronic document being requested and characteristics of locations of the electronic document at which digital component can be presented. For example, event data specifying a reference (e.g., URL) to an electronic document (e.g., webpage) in which the digital component will be presented, available locations of the electronic documents that are available to present digital components, sizes of the available locations, and/or media types that are eligible for presentation in the locations can be provided to the digital component distribution system 510. Similarly, event data specifying keywords associated with the electronic document (“document keywords”) or entities (e.g., people, places, or things) that are referenced by the electronic document can also be included in the component request 512 (e.g., as payload data) and provided to the digital component distribution system 510 to facilitate identification of digital components that are eligible for presentation with the electronic document. The event data can also include a search query that was submitted from the client device 506 to obtain a search results page, and/or data specifying search results and/or textual, audible, or other visual content that is included in the search results.

Component requests 512 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests 512 can be transmitted, for example, over a packetized network, and the component requests 512 themselves can be formatted as packetized data having a header and payload data. The header can specify a destination of the packet and the payload data can include any of the information discussed above.

The component distribution system 510 chooses digital components that will be presented with the given electronic document in response to receiving the component request 512 and/or using information included in the component request 512. In some implementations, a digital component is selected (using the techniques described herein) in less than a second to avoid errors that could be caused by delayed selection of the digital component. For example, delays in providing digital components in response to a component request 512 can result in page load errors at the client device 506 or cause portions of the electronic document to remain unpopulated even after other portions of the electronic document are presented at the client device 506. Also, as the delay in providing the digital component to the client device 506 increases, it is more likely that the electronic document will no longer be presented at the client device 506 when the digital component is delivered to the client device 506, thereby negatively impacting a user's experience with the electronic document. Further, delays in providing the digital component can result in a failed delivery of the digital component, for example, if the electronic document is no longer presented at the client device 506 when the digital component is provided.

In some implementations, the digital component distribution system 510 is implemented in a distributed computing system that includes, for example, a server and a set of multiple computing devices 514 that are interconnected and identify and distribute digital components in response to requests 512. The set of multiple computing devices 514 operate together to identify a set of digital components that are eligible to be presented in the electronic document from a corpus of millions of available digital components (DC1-x). The millions of available digital components can be indexed, for example, in a digital component database 516. Each digital component index entry can reference the corresponding digital component and/or include distribution parameters (DP1-DPx) that contribute to (e.g., condition or limit) the distribution/transmission of the corresponding digital component. For example, the distribution parameters can contribute to the transmission of a digital component by requiring that a component request include at least one criterion that matches (e.g., either exactly or with some pre-specified level of similarity) one of the distribution parameters of the digital component.

In some implementations, the distribution parameters for a particular digital component can include distribution keywords that must be matched (e.g., by electronic documents, document keywords, or terms specified in the component request 512) in order for the digital component to be eligible for presentation. In other words, the distribution parameters are used to trigger distribution (e.g., transmission) of the digital components over the network 502. The distribution parameters can also require that the component request 512 include information specifying a particular geographic region (e.g., country or state) and/or information specifying that the component request 512 originated at a particular type of client device (e.g., mobile device or tablet device) in order for the digital component to be eligible for presentation.

The distribution parameters can also specify an eligibility value (e.g., ranking score, bid, or some other specified value) that is used for evaluating the eligibility of the digital component for distribution/transmission (e.g., among other available digital components), for example, by the component evaluation process. In some situations, the eligibility value can specify a maximum amount of compensation that a provider of the digital component is willing to submit in response to the transmission of the digital component (e.g., for each instance of specific events attributed to the presentation of the digital component, such as user interaction with the digital component).

The identification of the eligible digital component can be segmented into multiple tasks 517a-517c that are then assigned among computing devices within the set of multiple computing devices 514. For example, different computing devices in the set 514 can each analyze a different portion of the digital component database 516 to identify various digital components having distribution parameters that match information included in the component request 512. In some implementations, each given computing device in the set 514 can analyze a different data dimension (or set of dimensions) and pass (e.g., transmit) results (Res 1-Res 3) 518a-518c of the analysis back to the digital component distribution system 510. For example, the results 518a-518c provided by each of the computing devices in the set 514 may identify a subset of digital components that are eligible for distribution in response to the component request and/or a subset of the digital components that have certain distribution parameters. The identification of the subset of digital components can include, for example, comparing the event data to the distribution parameters, and identifying the subset of digital components having distribution parameters that match at least some features of the event data.

The digital component distribution system 510 aggregates the results 518a-518c received from the set of multiple computing devices 514 and uses information associated with the aggregated results to: (i) select one or more digital components that will be provided in response to the request 512, and (ii) determine transmission requirements for the one or more digital components. For example, the digital component distribution system 510 can select a set of winning digital components (one or more digital components) based on the outcome of one or more component evaluation processes. In turn, the digital component distribution system 510 can generate and transmit, over the network 502, reply data 520 (e.g., digital data representing a reply) that enables the client device 506 to integrate the set of winning digital components into the given electronic document, such that the set of winning digital components and the content of the electronic document are presented together at a display of the client device 506.

In some implementations, the client device 506 executes instructions included in the reply data 520, which configures and enables the client device 506 to obtain the set of winning digital components from one or more digital component servers. For example, the instructions in the reply data 520 can include a network location (e.g., a Uniform Resource Locator (URL)) and a script that causes the client device 506 to transmit a server request (SR) 521 to the digital component server 508 to obtain a given winning digital component from the digital component server 508. In response to the request, the digital component server 508 will identify the given winning digital component specified in the server request 521 (e.g., within a database storing multiple digital components) and transmit, to the client device 506, digital component data (DC Data) 522 that presents the given winning digital component in the electronic document at the client device 506.

To facilitate searching of electronic documents, the environment 500 can include a search system 550 that identifies the electronic documents by crawling and indexing the electronic documents (e.g., indexed based on the crawled content of the electronic documents). Data about the electronic documents can be indexed based on the electronic document with which the data are associated. The indexed and, optionally, cached copies of the electronic documents are stored in a search index 552 (e.g., hardware memory device(s)). Data that are associated with an electronic document is data that represents content included in the electronic document and/or metadata for the electronic document.

Client devices 506 can submit search queries to the search system 550 over the network 502. In response, the search system 550 accesses the search index 552 to identify electronic documents that are relevant to the search query. The search system 550 identifies the electronic documents in the form of search results and returns the search results to the client device 506 in a search results page. A search result is data generated by the search system 550 that identifies an electronic document that is responsive (e.g., relevant) to a particular search query, and includes an active link (e.g., hypertext link) that causes a client device to request data from a specified network location (e.g., URL) in response to user interaction with the search result. An example search result can include a web page title, a snippet of text or a portion of an image extracted from the web page, and the URL of the web page. Another example search result can include a title of a downloadable application, a snippet of text describing the downloadable application, an image depicting a user interface of the downloadable application, and/or a URL to a location from which the application can be downloaded to the client device 506. In some situations, the search system 550 can be part of, or interact with, an application store (or an online portal) from which applications can be downloaded for install at a client device 506 in order to present information about downloadable applications that are relevant to a submitted search query. Like other electronic documents, search results pages can include one or more slots in which digital components (e.g., advertisements, video clips, audio clips, images, or other digital components) can be presented.

To select a digital component to be transmitted in response to a component request, the distribution system 510 may identify a set of digital components that are eligible to be transmitted in response to the component request. The distribution system 510 may then select one or more of the eligible digital components to be transmitted through, e.g., an auction procedure. In some implementations, the distribution system 510 performs an auction procedure by ranking the eligible digital components in accordance with their respective eligibility values, and selecting one or more highest-ranked digital components to be transmitted in response to the component request.

For example, the distribution system 510 may identify digital components A, B, and C as eligible to be transmitted in response to a component request. In this example, digital component A has an eligibility value of $5, digital component B has an eligibility value of $1, and digital component C has an eligibility value of $5.5, where the eligibility values of the digital components represent bids associated with the digital components. The distribution system 510 may rank (e.g., in descending order) the digital components in accordance with their respective eligibility values as: C, A, B. Finally, the distribution system 510 may select the highest ranked digital component C for transmission in response to the component request

After selecting a digital component to be transmitted in response to a digital component request, the distribution system 510 determines a transmission requirement for the selected digital component. A transmission requirement specifies an action to be performed by the provider of a digital component in response to a transmission of the digital component. For example, the transmission requirement may specify that the provider of the digital component submit an amount of compensation in response to the transmission of the digital component. In some cases, the amount of compensation specifies an amount to be submitted for each instance of specific events attributed to the presentation of the digital component (e.g., user interactions with the digital component).

The distribution system 510 may determine the transmission requirement of the selected digital component based on the eligibility value of the selected digital component and/or the eligibility values of the other digital components that were determined as eligible to be transmitted in response to the component request. For example, the distribution system 510 may identify digital components A, B, and C as eligible for transmission in response to a digital component request, where A, B, and C have respective eligibility values of $5, $1, and $5.5. The distribution system 510 may select digital component C for transmission (since it has the highest eligibility value), and may determine the transmission requirement for digital component C to be the next highest eligibility value from amongst the eligibility values of the eligible digital components. In this example, next highest eligibility value is $5 (i.e., the eligibility value of digital component A), and therefore the distribution system 510 may determine the transmission requirement of digital component C to be $5.

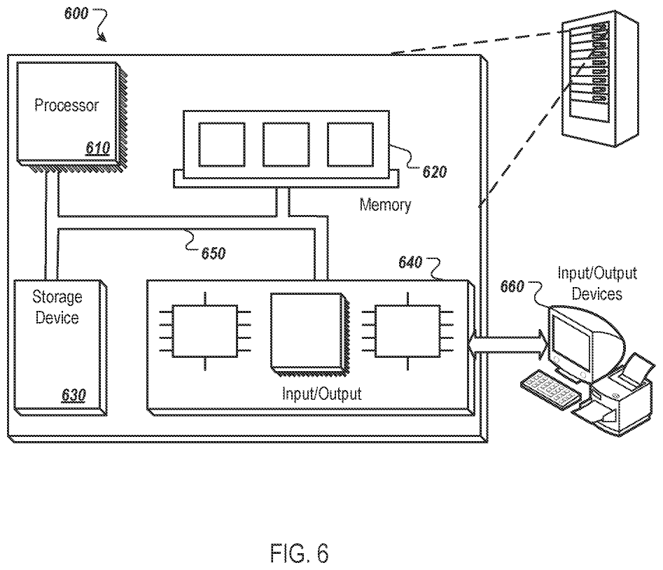

FIG. 6 is a block diagram of an example computer system 600 that can be used to perform operations described above. The system 600 includes a processor 610, a memory 620, a storage device 630, and an input/output device 640. Each of the components 610, 620, 630, and 640 can be interconnected, for example, using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630.

The memory 620 stores information within the system 600. In one implementation, the memory 620 is a computer-readable medium. In one implementation, the memory 620 is a volatile memory unit. In another implementation, the memory 620 is a non-volatile memory unit. The storage device 630 is capable of providing mass storage for the system 600. In one implementation, the storage device 630 is a computer-readable medium. In various different implementations, the storage device 630 can include, for example, a hard disk device, an optical disk device, a storage device that is shared over a network by multiple computing devices (e.g., a cloud storage device), or some other large capacity storage device.

The input/output device 640 provides input/output operations for the system 600. In one implementation, the input/output device 640 can include one or more network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 660. Other implementations, however, can also be used, such as mobile computing devices, mobile communication devices, set-top box television client devices, etc.

Although an example processing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers for privacy-sensitive assessment of digital component transmission reach based on cardinalities of subset unions of a collection of user sets, the method comprising:
receiving a request to determine a number of users that are included in a target group of users that received at least one transmission of a digital component, wherein:
the request comprises a set expression specifying the target group of users;
the set expression is defined in terms of the collection of user sets; and
each user set comprises one or more users satisfying a set-specific inclusion criterion; and
in response to receiving the request:
generating an alternative representation of the set expression in terms of primitive sets of the collection of user sets;
applying a cardinality model having a set of cardinality model parameters to each primitive set included in the alternative representation of the set expression to generate a cardinality of each primitive set as a linear combination of cardinalities of subset unions of the collection of user sets;
determining the number of users included in the target group of users based on the cardinalities of the primitive sets included in the alternative representation of the set expression; and
automatically providing a notification identifying the number of users included in the target group of users in response to the request.

2. The method of claim 1, wherein the cardinality model is defined by a matrix, wherein the cardinality model parameters define entries of the matrix, wherein the entries of the matrix define weights of linear combinations used to generate cardinalities of primitive sets in terms of cardinalities of subset unions.

3. The method of claim 2, wherein for each primitive set included in the alternative representation of the set expression, applying the cardinality model to the primitive set comprises:
mapping the primitive set to: (i) a collection of subset unions, and (ii) for each subset union, a respective weight of the subset union in the linear combination; and
generating the cardinality of the primitive set as a linear combination of the cardinalities of the subset unions weighted by the weights of the subset unions.

4. The method of claim 2, wherein the entries of the matrix comprise −1, 0, and +1.

5. The method of claim 2, wherein the matrix defining the cardinality model is a sparse matrix.

6. The method of claim 1, wherein the set of cardinality model parameters are precomputed.

7. The method of claim 1, wherein the set of cardinality mode parameters are dynamically generated in response to receiving the request.

8. The method of claim 1, wherein a primitive set of the collection of user sets is defined by a set intersection that intersects, for each user set in the collection of user sets, either the user set or a complement of the user set.

9. The method of claim 1, wherein a subset union of the collection of user sets is defined by a set union of one or more user sets in the collection of user sets.

10. The method of claim 1, wherein generating the alternative representation of the set expression in terms of primitive sets of the collection of user sets comprises:
replacing each user set in the set expression by a union of corresponding primitive sets.

11. The method of claim 1, wherein, for each user set in the collection of user sets, the set-specific inclusion criterion specifies that users included in the user set received at least one transmission of the digital component by way of a respective publisher.

12. The method of claim 1, wherein, for each user set in the collection of user sets, the set-specific inclusion criterion specifies that users included in the user set received at least one transmission of the digital component in a respective window of time.

13. The method of claim 1, wherein the set expression is defined as a string comprising set identifiers and set operations.

14. The method of claim 13, wherein the set operations include one or more of: set union operations, set intersection operations, and set difference operations.

15. A system comprising:
one or more computers; and
one or more storage devices communicatively coupled to the one or more computers, wherein the one or more storage devices store instructions that, when executed by the one or more computers, cause the one or more computers to perform operations for privacy-sensitive assessment of digital component transmission reach based on cardinalities of subset unions of a collection of user sets, the operations comprising:
receiving a request to determine a number of users that are included in a target group of users that received at least one transmission of a digital component, wherein:
the request comprises a set expression specifying the target group of users;
the set expression is defined in terms of the collection of user sets; and
each user set comprises one or more users satisfying a set-specific inclusion criterion; and
in response to receiving the request:
generating an alternative representation of the set expression in terms of primitive sets of the collection of user sets;
applying a cardinality model having a set of cardinality model parameters to each primitive set included in the alternative representation of the set expression to generate a cardinality of primitive set as a linear combination of cardinalities of subset unions of the collection of user sets;
determining the number of users included in the target group of users based on the cardinalities of the primitive sets included in the alternative representation of the set expression; and
automatically providing a notification identifying the number of users included in the target group of users in response to the request.

16. One or more non-transitory computer storage media storing instructions that when executed by one or more computers cause the one or more computers to perform operations for privacy-sensitive assessment of digital component transmission reach based on cardinalities of subset unions of a collection of user sets, the operations comprising:
receiving a request to determine a number of users that are included in a target group of users that received at least one transmission of a digital component, wherein:
the request comprises a set expression specifying the target group of users;
the set expression is defined in terms of the collection of user sets; and
each user set comprises one or more users satisfying a set-specific inclusion criterion; and
in response to receiving the request:
generating an alternative representation of the set expression in terms of primitive sets of the collection of user sets;
applying a cardinality model having a set of cardinality model parameters to each primitive set included in the alternative representation of the set expression to generate a cardinality of primitive set as a linear combination of cardinalities of subset unions of the collection of user sets;
determining the number of users included in the target group of users based on the cardinalities of the primitive sets included in the alternative representation of the set expression; and
automatically providing a notification identifying the number of users included in the target group of users in response to the request.

17. The one or more non-transitory computer storage media of claim 16, wherein the cardinality model is defined by a matrix, wherein the cardinality model parameters define entries of the matrix, wherein the entries of the matrix define weights of linear combinations used to generate cardinalities of primitive sets in terms of cardinalities of subset unions.

18. The one or more non-transitory computer storage media of claim 17, wherein for each primitive set included in the alternative representation of the set expression, applying the cardinality model to the primitive set comprises:
mapping the primitive set to: (i) a collection of subset unions, and (ii) for each subset union, a respective weight of the subset union in the linear combination; and
generating the cardinality of the primitive set as a linear combination of the cardinalities of the subset unions weighted by the weights of the subset unions.

19. The one or more non-transitory computer storage media of claim 17, wherein the entries of the matrix comprise −1, 0, and +1.

20. The one or more non-transitory computer storage media of claim 17, wherein the matrix defining the cardinality model is a sparse matrix.
